(19) United States
(12) Patent Application Publication
(10) Pub. No.: US 2010/0211485 A1
(43) Pub. Date: Aug. 19, 2010

(54) SYSTEMS AND METHODS OF TIME PERIOD COMPARISONS

(76) Inventors: Nancy L. Augustine, Pleasant Hill, CA (US); John Carr, Antioch, CA (US); Ben Goldberg, Pleasanton, CA (US); Randall Jones, Carrollton, TX (US); Cheryl L. Paterson, Alameda, CA (US); Ev Shafrir, Mountain View, CA (US); Gregg Stratton, San Francisco, CA (US)

Correspondence Address: WILSON, SONSINI, GOODRICH & ROSATI, 650 PAGE MILL ROAD, PALO ALTO, CA, 94304-1050, US

(21) Appl. No.: 12/372,360

(22) Filed: Feb. 17, 2009

(51) Int. Cl. G06Q 10/00

(52) U.S. Cl. 705/32

(57) ABSTRACT

The invention provides systems and methods of time period comparison. A user interface, which may be a part of a payroll or human capital management application or software, may be provided which may display payroll items, along with values for the payroll items during a first time period and second time period, as well as the differences in the values for the payroll items between the first and second time periods. A user may select one or more time periods or bases of comparison to be compared and a user interface may display values relating to the time periods accordingly.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provided an employer with the ability to analyze the payroll or other human capital management in a myriad of respects appropriate to identifying appropriate events. Such automation systems also permitted a means of comparison of information, such as payroll information for a current pay period to payroll information for an earlier pay period. However, such automation systems failed to provide a user display of payroll or other human capital management information comparing time periods that incorporated multiple units of comparison, that changed a portion of an interface based on a time period selection, that incorporated check worksheets, or that incorporated various organizational or visual indication tools to assist with time period comparison. Such payroll systems failed to visually incorporate the concept of trends and changes.

There is a need for improved systems and methods for displaying time period comparisons, especially for data including payroll or human capital management data, in a visual manner that can better display differences between time periods, or trends.

### SUMMARY OF THE INVENTION

The invention provides systems and methods for displaying time period comparisons, such as comparisons of data values between pay periods. Various aspects of the invention described herein may be applied to any of the particular applications set forth below or for any other types of user interfaces and displays. The invention may be applied as a standalone system or method, or as part of an integrated software package, such as a payroll software or application. It shall be understood that different aspects of the invention can be appreciated individually, collectively, or in combination with each other.

One aspect of the invention provides for a user interface on a display. For example, the implementation of software may include a client computer comprising a video display, with at least one display page comprising data. The data may include payroll software data. The user interface may include panes providing access to data relating to given time categories or other bases of comparison. A pane may include a region of the user interface display. A pane may provide access to data in one or more different manners. Providing access to data may include any activity that may lead to creating using, modifying, or viewing the data. The panes do not need to provide access to data in the same manner or format.

The data may include any data that relates to a time category, time period or other basis of comparison. In a preferable embodiment of the invention, the data may include human capital management data, such as payroll data. A time category may include any data sequence, which may include a given period of time or may relate to data status. A given period of time may relate to any length of time, whether the length of time may relate to calendar units of time, smaller measurement units of time, or event-driven units of time. In a preferable embodiment of the invention, a given period of time may be a pay period. Data status may relate to the status of data, which may or may not be related to the passage of time. Other bases of comparison may include theoretical or average data for a supposed time category or period.

In accordance with one aspect of the invention, a user interface for displaying payroll or human capital management data may be provided. The user interface may include an item list pane providing access to a list of human capital management items; a first time period pane, providing access to data relating to a first time period and to the list of human capital management items; a second time period pane, providing access to data relating to a second time period and to the list of human capital management items; and a differences pane providing access to data relating to differences in the data provided by the first time period pane and the second time period pane. The data provided by the first time period pane, second time period pane, and differences pane may be visually mapped to the list of human capital management items, and may comprise data in a first unit and in a second unit, such as dollars or hours.

Another aspect of the invention may provide a method for managing human capital management data. The method may include providing a user interface comprising a time period selection zone, capable of accepting at least one time period selection from a user; a first time period summary pane; a second time period summary pane; an item list providing access to a list of human capital management items; a first time period details pane and a second time period details pane which are visually associated with the first time period summary pane and the second time period summary pane respectively, as well as to the list of human capital management items; and a differences pane providing access to data relating to differences in the data relating to the first time period and data relating to the second time period. The method may also include accepting a time period selection from a user through the time period selection zone. Additionally, the method may include displaying the second time period summary pane, the second time period detail pane, and the differences pane, wherein the data provided by those panes relate to the user's time period selection.

A user interface for human capital management may be provided in accordance with another aspect of the invention. The user interface may include a first check worksheet with check information relating to a first time period, wherein the check information is provided in at least one category; a second check worksheet with check information relating to a second time period, wherein the check information is provided in at least one category; a first time period pane displaying check information relating to the first time period; a second time period pane displaying check information relating to the second time period; and a differences pane displaying check information relating to the difference between check information relating to the first time period and check information relating to the second time period.

A user interface may also include any visual indicators that may assist with highlighting differences between two or more time periods or other bases of comparison. Such visual indicators may accentuate situations where there are larger differences or may indicate trends. Furthermore, an analytical perspective with visual indicators may be provided that may show how a selected time period may compare to a group of other time periods (e.g., historical data, or projected future trends).

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a system with client computers interacting with a server over a network.

FIG. 2 shows a user interface with an item list pane, a first time period pane, a second time period pane, and a differences pane.

FIG. 3 shows a user interface with a time period selection, a fixed time period summary, a variable time period summary, an item list, fixed time period details, variable time period details, and differences.

FIG. 4 shows a user interface with a first time period check worksheet, a second time period check worksheet, first time period check information, second time period check information, and differences check information.

FIG. 5 shows an example of a user interface for time period comparison in accordance with one embodiment of the invention.

FIG. 6 shows an example of a user interface for time period comparison in accordance with another embodiment of the invention.

FIG. 7 shows an example of visual difference indicators that may be incorporated into a user interface for time period comparison.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

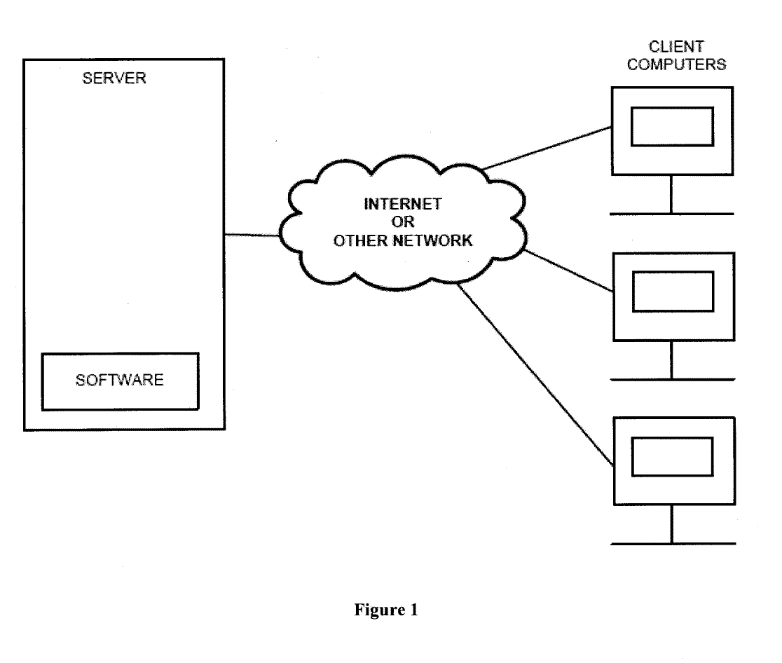

A user interface provided in accordance with the invention herein may be displayed across a network such as the Internet. For example, as shown in FIG. 1, an implementation may include a client computer comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal. Human capital management data may include data that can be person and time dependent. Human capital management may be heterogeneous across different businesses and a human capital management outsourcing software may advantageously display human capital management data. Any discussion herein relating to payroll data may be applied to human capital management data, and vice versa. Furthermore, any discussion herein may also be applied to the comparison of any other types of data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which may be transmitted from a server over a network to a client computer, which can store it in memory. A client computer may receive computer readable media, which may contain instructions, logic, data, or code that may be stored in persistent or temporary memory of the client computer, or may somehow affect or initiate action by a client computer. Similarly, one or more servers may communicate with one or more client computers across a network, and may transmit computer files residing in memory. The network, for example, can include the Internet or any network for connecting one or more clients to one or more servers.

At a client computer, the display page may be interpreted by software residing in memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Any computer readable media with logic, code, data, instructions, may be used to implement any software or steps or methodology. Where a network comprises the Internet, a display page may comprise a webpage of a type known in the art.

A display page according to the invention may include embedded functions comprising software programs stored on a memory device, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, menu option, or hyperlink also is known as “selecting” the button, option, or hyperlink. A display page according to the invention also may incorporate multimedia features.

A user interface may be displayed on a video display and/or display page. A server and/or client computer may have access to human capital management or payroll software. A user interface may be used to display or provide access to human capital management or payroll data.

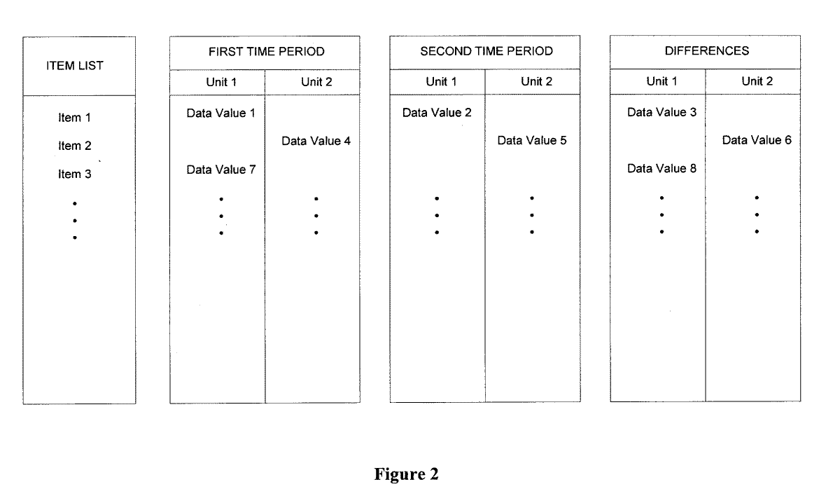

In accordance with one aspect of the invention, FIG. 2 shows a user interface that may include an item list pane, a first time period pane, a second time period pane, and a differences pane. The user interface may include panes providing access to data relating to given time categories or other data categories or bases of comparison. A pane may include a region of the user interface display. For example, a pane may have a defined geometric shape, such as a rectangle. In another example, a pane may have any defined shape, even if it irregular. A shape may be defined by some sort of visual cue, such as a border or color change. A pane need not have a visual indication of the pane's boundaries. Alternatively, the pane itself may not have a defined shape, but may include a region which may provide access to data relating to a time category.

A pane may provide access to data in one or more different manners. Providing access to data may include any activity that may lead to creating, using, modifying, or viewing the data. For example, a pane may provide visual access to data by displaying the data within the pane. A pane may also provide access to data by providing a link or button or any other option that may enable a user to see the data in another view. Providing access to data may also include allowing a user to perform a function with the data, such as creating a new data object, editing existing data, or printing an item using the data. The panes do not need to provide access to data in the same manner or format.

The data may include any data that may relate to a time category, time period, or other basis of comparison. A time category may include any data sequence, which may include a given period of time or may relate to data status. Both periods of time and data statuses may have a sequence. An earlier time category, where the time category may relate to a period of time, may include a time period that is earlier in time. An earlier time category, where the time category may relate to data status, may include data status that is farther along in a sequence and vice versa, since data from an earlier time may be further along in a status sequence. So for example, a time category for submitted payroll data may be considered earlier than a time category for open payroll data even if submitted payroll data is further along in a sequence because submitted payroll data relates to data from an earlier time. Similarly, submitted payroll data may also be considered to precede or be prior to open payroll data. Any discussion herein for a time period may also apply to any time category, and vice versa. So any discussion herein of time period comparison may also apply to comparison with any time category, which may include a period of time or data status.

A given period of time may relate to any length of time, whether the period of time relate to calendar units of time, smaller measurement units of time, or event-driven units of time. In a preferable embodiment of the invention, a given period of time may be a pay period. A pay period in the payroll processing art may be the intervals that employees are paid at, and may usually be chosen by an employer. Commonly, employees may be paid weekly, biweekly, semimonthly, or monthly, although other pay periods are possible. The period of time may be adaptable for any pay period desired by an employer. For example, a period of time could change from a month to a week if an employer were to change monthly pay periods to weekly pay periods.

In an alternate embodiment, the given period of time may be based on calendar units such as years, months, weeks, days. In another embodiment, the periods of times may be for smaller measurement units of time, such as hours, minutes, seconds, or portions thereof. In other embodiments, periods of time may vary in length and may be an event-driven unit of time, or may occur when an administrator of a system may decide to change the time period, and so forth.

Data status may relate to the status of data, which may or may not be related to the passage of time. Data status may have a sequence or progression so that data starts out with a particular status, then progresses to another status, and so forth. For example, payroll data may start as unopened payroll data, then become opened payroll data, then become submitted payroll data. Data status may be related to time if status sequence may be related to time. For instance, payroll data may start as unopened payroll data, and after some time may become opened payroll data, and after some additional time may become submitted payroll data. As discussed previously, an earliest time category, where the time category may relate to data status, may include data status that is farthest along in a sequence and vice versa, since data from an earlier time may be further along in a status sequence. For example, an earlier time category may include a pay period that was closed earlier or that occurred earlier in time.

In a preferable embodiment of the invention, the data may include payroll data. Such payroll data may include data pertaining to employees, associated partners, or other pertinent parties. Payroll data may related to information such as payroll liability and payroll progress, such as worksheets for various employee groups, various payroll items and amounts, information on already submitted payroll, whether processing is complete, whether direct deposits or checks were sent, and so forth. The data may also include any other human capital management data.

In a preferable embodiment of the invention, the user interface may include an item list pane. The item list pane may provide access to data pertaining to various payroll or other human capital management items. For example, an item list pane may provide a list of payroll or other human capital management items including but not limited to: advance, bonus, holiday pay, overtime, regularly hourly, retroactive pay, salary pay, or vacation pay. In some embodiments, the items displayed within an item list pane may be written out, abbreviations may be used, or symbols, colors, or any other visual indicators representing the items may be used.

Within an item pane, the list of items may be arranged in any manner. In one embodiment, the list of items may be displayed in a linear manner. The linear display may have any orientation. For example, the list of items may be displayed as a vertical list, e.g., as shown in FIG. 2. In other embodiments, the list of items may be displayed as a horizontal list. Alternatively, the list of items may be displayed in a diagonal or staggered manner.

The items within an item list pane may be displayed such that they form a linear display such that the items are all at the same level, e.g., Item 1, Item 2, Item 3, etc. In other implementations, the items in the item list pane may be arranged into groupings or have some form of organization that may be visually apparent. For example, there may be categories of items, and the items may be displayed below the categories and indented, or have any other visual indication that the items are associated with an item category. In some embodiments, an item list pane may initially display a list of item categories and it may be possible to drill down into an item category to get access to the items within the item category. One example of drilling down may include a drill down list where item categories with one or more items may include a visual indicator that a user may select, which will allow the items within the item category to appear in the list below the item category. Thus, items within an item list pane may be displayed in a manner such that they are or are not associated with an item category in a visual manner, and such that items may or may not be hidden at a user's discretion. When items are hidden, associated values for the hidden items, which may belong to other panes, may be hidden as well.

The user interface may also include a first time period pane and a second time period pane. A first time period pane may provide access to data relating to the first time period and to the items within the item list. A second time period pane may provide access to data relating to the second time period and the items within the item list. The first time period and second time period may refer to any time period, time category, or basis of comparison. The second time period may occur earlier or later than the first time period, or may be the same as the first time period.

In a preferable embodiment of the invention, the first time period may be a current pay period, and the second time period may be a pay period prior to the current pay period. Or in some cases, the first time period may be any pay period, and the second time period may be a pay period prior to the first time period. In some embodiments, the time periods may be provided such that: the first and second time periods are fixed, the first time period is fixed and the second time period is variable, the first time period is variable and the second time period is fixed, or the first and second time periods are variable. When a time period is variable, a user may select the time period.

The first and second time period panes may provide access to data relating to items within the item list. For example, a time period pane may display data relating to an item in the item list. For example, an item in the item list, such as Item 1, may have a data value during the first time period and during the second time period, which may be Data Value 1 during the first time period, and Data Value 2 during the second time period. Similarly, another item in the item list, such as Item 2, may have a data value during the first time period and during the second time period, which may be Data Value 4 and Data Value 5.

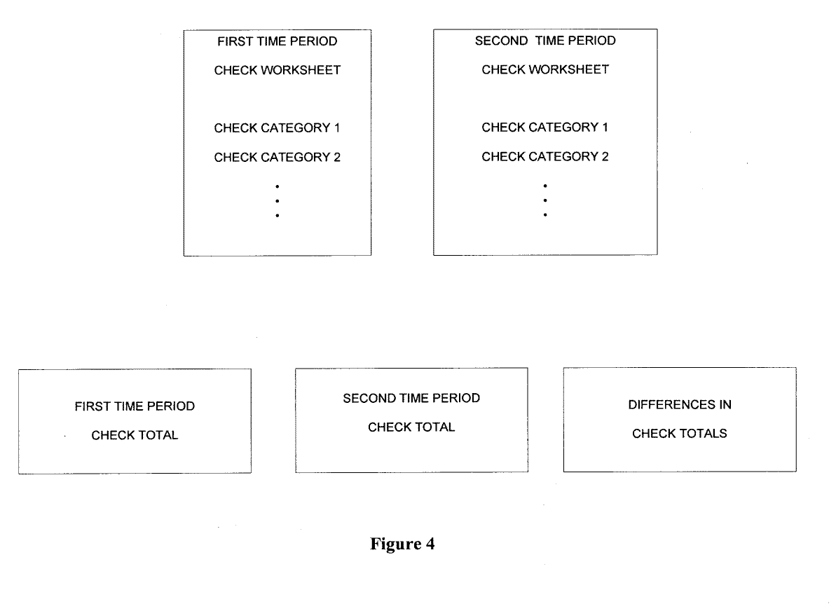

The data values displayed for a particular item may be the value of that item during a particular time period. For example, as shown in FIG. 4, if an item is a Bonus (BON), and the Bonus may have a $4,500.00 value for a current payroll period, and may have no value during a selected payroll period (e.g., which may indicate no Bonus was paid out in the selected pay period), such values may be displayed in the first and second time period panes respectively. If there is no value for an item during a time period, the time period pane may not list any value for the item, or alternatively may list a zero or null value for the item.

In some embodiments, an item may not have a value during one or more of the time periods. For example, an item in the item list, such as Item 3, may have a value during the first time period, such as Data Value 7, but may not have a value during the second time period. For instance, this may occur during a payroll application when vacation may be taken during one time period, but not during another. In other examples, some items on the item list may not have a value during any of the time periods (e.g., the time periods displayed on the user interface, such as the first and second time periods). For instance, no advances may be provided during any of the time periods being compared.

The user interface may also include a differences pane. The differences pane may include values that are calculated as the difference between the values in the first time period and the second time period pane. For example, if Item 1 has a value Data Value 1 during the first time period, and a value Data Value 2 during the second time period, the value displayed in the differences pane may be Data Value 3 where Data Value 3=Data Value 1−Data Value 2. In some cases, a data value for an item in the differences pane may be a value for that item during a current pay period minus the value for that item during a prior pay period. In some alternate embodiments of the invention, the data value for an item in the differences pane may be the value for that item during the second time period minus the value for that item during the first time period. If an item does not have a value during a time period, when calculating the difference, the value of the item at that time period may be treated as zero, or a nullity. For example, the differences value for Item 3 may be Data Value 8, where Data Value 8=Data Value 7−0=Data Value 7.

In some embodiments of the invention, additional time period panes may be provided. Additional time period panes need not be included in the differences pane calculation. Or a differences pane may include values for differences between multiple combinations of time period panes. For instance, a differences pane may include values that may reflect a difference between values in a first time period pane and second time period pane, and between values in a first time period pane and a third time period pane. Any discussion relating to two time periods for comparison may be applied to any number of time periods or bases of comparison.

The data values displayed (or provided access to) within the first time period pane, a second time period, and differences pane may be visually mapped to the items provided in the item list pane. A first object may be visually mapped to a second object if they are somehow visually aligned or correspond, or show a relationship between the first and second object. For instance, one example of visual mapping between a plurality of objects may occur when the plurality of objects are in the same row or column (e.g., given an x-y coordinate system, a plurality of objects may be visually mapped if they share the same x-coordinate while the y-coordinate may vary, or if they share the same y-coordinate while the x-coordinate may vary).

In one example, the various panes may be arranged such that they are adjacent to one another. For example, in some embodiments, the item pane, the first and second time period panes, and the differences pane may have a linear arrangement. For example, they may be arranged horizontally adjacent to one another. For instance, a user interface may be provided where an item list pane is to the left of a first time period pane which is to the left the second time period pane, which is to the left of the differences pane. A first time period pane may have two opposing sides and an item list pane may be adjacent to the first time period pane, and a second time period pane may be adjacent to the first time period pane opposing the item list pane. The second time period pane may also have two opposing sides and a differences pane may be adjacent to the second time period pane opposing the first time period pane. The panes may be horizontally adjacent to one another in any order. Alternatively, the panes may have a vertical linear configuration. For example, an item list may be placed above a first time period pane, which may be placed above a second time period pane, which may be placed above a differences pane. Or the panes may have any arrangement or configuration which may or may not be linear.

In an example where the panes have a substantially horizontal linear arrangement, the items in an item list may be displayed vertically. The data values displayed in a pane may be visually mapped or associated with an item in the item list. For example, if an item list has an Item 2, the data values corresponding to Item 2 in the other panes may be along the same horizontal row as Item 2. For example, Item 2, Data Value 4, Data Value 5, and Data Value 6 may all be on the same horizontal row. Thus the items and values may be displayed in the various panes such that values corresponding to an item may be visually associated with that item. Similarly, if the panes have a substantially vertical linear arrangement, the items in the item list may be displayed horizontally, and may correspond to data values within the same vertical column.

The data provided by the first time period pane, the second time period pane, and the differences pane may comprise data in a first unit and data in a second unit. Units may refer to different categories or types of values that may be provided by the data. For example, one unit may be in dollars, another unit may be in hours, another may be in days, and so forth. The first unit and the second unit may be any units or combination of units. For instance, the first unit may be dollars and the second unit may be hours.

In some implementations, a pane may include one or more zones or regions, where each zone or region may display data values corresponding to a unit associated with the zone or region. For example, a pane may include a first column which may display data values corresponding to a first unit, and a second column which may display data values corresponding to a second unit. For example, a first time period pane, second time period pane, and differences pane may have a first column which may display data values that are in hours, and a second column which may display data values that are dollar values. Zones/regions for units may have any configuration, such as rows, or in some instances may be combined such that data of multiple units may appear in the same area of the pane. For example, a first and second unit may fall under a column. A third unit may be displayed in another column.

For example, as shown in FIG. 2, Data Value 1, Data Value 2, and Data Value 3 associated with Item 1 may have a value in a first unit, which may fall under a first column. Data Value 4, Data Value 5, and Data Value 6 associated with Item 2 may have a value in a second unit, and the data may be displayed under a second column. Data Value 7 and Data Value 8 may have a value in the first unit, and may thus be displayed under the first column. In some instances, an item may have a data value that only falls under one unit. Alternatively, an item may have a data value that can translate to a plurality of units. For example, an item may be for vacation used, which may translate to a number of hours used for vacation, or which may also have a dollar value that corresponds to the number of hours used. In instances where an item may have a data value in a plurality of units, the user interface may display the data value under the plurality of units, or may select a unit for which to display the data item. For example, if someone used 8 hours of vacation, the user interface may display only “8” in an hours column, or may display both “8” in an hours column and a corresponding dollar value such as “$400” in a dollars column.

Any number of units and corresponding zones or regions may be provided. For example, one, two, three, or more units may be provided. In some embodiments, each time period pane may have a zone or region for a particular unit, wherein the placement or configuration of the zone or region may correspond for other time period or differences panes. For example, if a first time period pane has a column on the left for hours, and column on the right for dollars, a second time period pane and differences pane may also have a column on the left for hours and a column on the right for dollars. In alternate embodiments, the zones or regions for units need not match up or correspond between multiple panes.

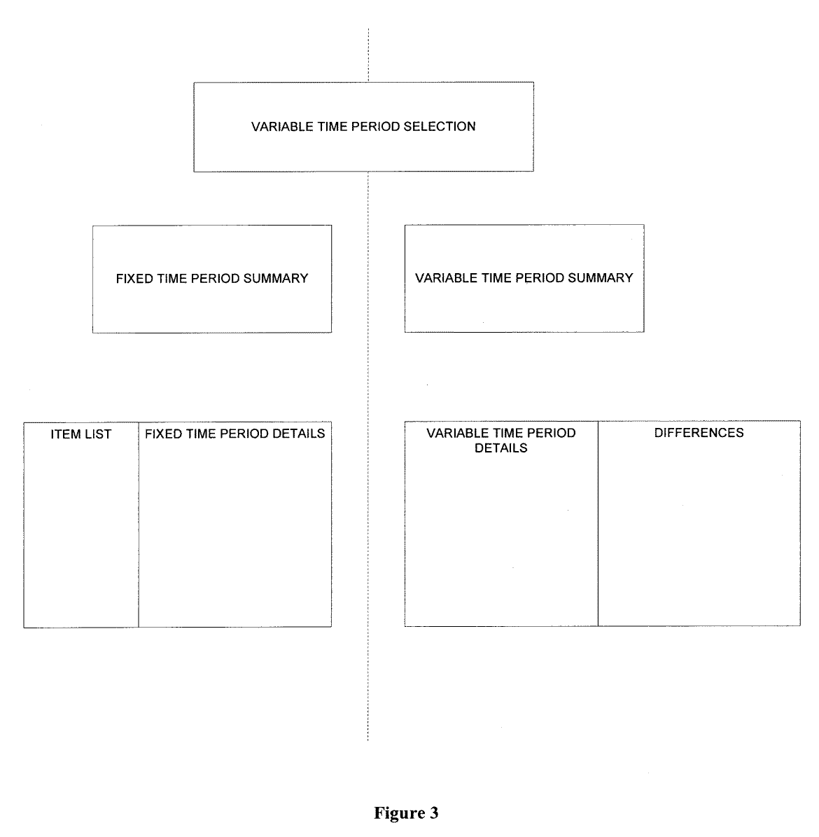

FIG. 3 shows a user interface in accordance with another aspect of the invention, which may include a time period selection, a fixed time period summary, a variable time period summary, an item list, fixed time period details, variable time period details, and differences. Any of the sections of the user interface may or may not be part of a pane. For example, a user interface may include a variable time period selection pane, a first time period summary pane, a second time period summary pane, an item list, a first time period detail pane, a second time period detail pane, and a differences pane. A pane may or may not have visual indicators indicating the pane, as discussed previously. Thus, summary information, as well as further details pertaining to a time period, may be displayed on the same page or user interface.

A variable period selection may enable a user to select a time period, time category, or other basis of comparison. A user may select one or more time period or other basis of comparison through any user interactive techniques known or later developed in the art. For example, a variable period selection may include a drop down menu which may present options to a user that a user may select. Alternatively, the variable period selection may include buttons, a field for entering a data value, a checkbox, a visual timeline, icons, or any other user interfacing techniques that may enable a user to select a time period or other basis of comparison. In some embodiments, a user may only select one variable time period or basis of comparison. In other embodiments, a user may select multiple time periods or bases of comparison.

A basis of comparison may include any real or theoretical set of data that may be compared with another set of data. For example, a basis of comparison may be data from a time period, such as a prior pay period. A basis of comparison could be a data status, such as a submitted pay period. A basis of comparison may also be a base set or master set of data (such as payroll codes). In one case, a current pay period may be compared to the base set to see what data may be added or what data may be missing. Another form of basis of comparison may include an average set of data over a longer specified time range. For example, a current pay period may be compared to the averaged value from the pay periods over the past year or other length of time. Thus, the current time period may be compared to determine how it deviates from the average pay period. A basis of comparison may also include a projected future set of data.

Another example of a basis of comparison may be a computed benchmark period. For instance, a benchmark period may be a projected average payroll expense based on a year's budget. Thus, a time period may be compared against the benchmark period to determine if the time period is helping to stay within the budget or going over the budget. For example, if a pay period is a week long, a benchmark period may include a projected 52 week average weekly payroll expense that may be desired to stay within budget. Any discussion of a user selected time period may also be applied to a time category or basis of comparison.

In one embodiment of the invention, a first time period may be fixed and a second time period may be variable. The first time period may be fixed as the current pay period. When a first time period is fixed, a first time period summary pane and first time period details may not change based on selection by a user of a variable time period or other basis of comparison. When the second time period is variable, the second time period summary pane and the second time period detail pane may change based on the user selection of a variable time period or other basis of comparison. By changing values displayed within a second time period detail pane, the values within a differences pane may change as well, because the values within a differences pane may depend on the difference between the values displayed within the first and second time period detail panes.

Thus, in some implementations of the user interface, a first time period summary and first time period details may be visually mapped or associated with one another. Accordingly, a second time period summary and second time period details may be visually mapped or associated with one another. For example, a first time period summary and first time period details may be displayed on one side of the user interface. For example, there may be a vertical line (which may or may not be visible) which may somehow separate the data associated with the first time period and the data associated with the second time period. When the first time period is fixed and the second time period is variable, the data to the left of the line may not change, while the data to the right of the line may change with user selection of a time period. In some embodiments, the item list may be adjacent to the first time period details, and the differences may be adjacent to the second time period details, although the positions of the item list and the differences may be switched or varied.

The visible or invisible line that may separate data associated with a first time period and a second time period need not be vertical. In another embodiment, the line may be horizontal. In another embodiment, the line may not be a straight line, or even exist as a line at all, but may just indicate that one region of a user interface may be associated with a first time period and another region of a user interface may be associated with a second time period.

In one example, the first time period may be fixed as a current pay period. A user may select a time period prior to the current pay period. In some embodiments, there may be a default second time period such that when a user accesses the user interface, the display may also include second time period summary and details based on the default second time period. In one instance, the default second time period may be the pay period immediately prior to the current pay period. For example, if a current pay period is for the month of August, the immediately prior pay period may be for the month of July. However, if a default pay period exists, it may be any time period prior to the current pay period, or other basis of comparison. In another embodiment, there may not be a default value, and the panes for displaying a second time period summary and second time period details may be blank accordingly, or may not be displayed.

When a user selects a variable time period, if the variable time period changes, then the display for the variable time period summary and details, and differences may adjust accordingly. For instance, if a current pay period is for the month of August, and the default variable time period was set at July, and a user changes the variable time period to June, the variable time period summary pane and the variable time period details pane may display or provide access to data relating to June. The values displayed or accessed by the differences pane may also correspondingly change to reflect the difference in data value between August and June rather than August and July. A user may accordingly select any other prior pay period, such as a pay period for April, or January, or a pay period from a previous year. A user may also accordingly select another basis of comparison such as an average pay period or computed benchmark period. In some embodiments, there may be a limit to how far back a user may select a time period, while in other embodiments, the only limit may be how far back payroll data exists. Similarly, if a user selects the same variable time period as was previously displayed, then there may be no change in the user interface display.

As discussed previously, in some embodiments, the first time period and/or the second time period may be fixed or variable. Thus, the panes that may or may not change with a user selector may be adjusted accordingly. For example, in one embodiment, a user may vary both time periods, which may result in panes associated with the first time period and panes associated with the time periods changing with the user selection. Thus, a user can compare any two pay periods to compare data within the pay periods.

In some instances, the item list, the first time period details, the second time period details, and the differences may have any configuration, which may include configurations discussed previously relating to an item list pane, first time period pane, second time period pane, and differences pane.

Thus, a method for managing human capital management or payroll data may be provided where a user interface may be provided. The user interface may be presented to a user on a video display. The user interface may accept one or more time period selections from a user. One or more parts of the user interface may be displayed that relies upon the user time period selection. In some embodiments, a second time period summary, second time period details, and differences may be displayed that may relate to the user time period selection.

FIG. 4 shows a user interface with a first time period check worksheet, a second time period check worksheet, first time period check information, second time period check information, and differences check information, in accordance with another aspect of the invention. A first time period check worksheet may provide access to check information relating to a first time period, and a second time period check worksheet may provide access to check information relating to a second time period.

In some embodiments of the invention, the first and second check worksheets may provide check information in at least one category. For example, the first and second check worksheets may include information relating to checks, such as payroll checks, where the information may be categorized into one or more check categories. Some examples of check categories may include but are not limited to: weekly payroll, voids/manuals, bonuses, or commissions.

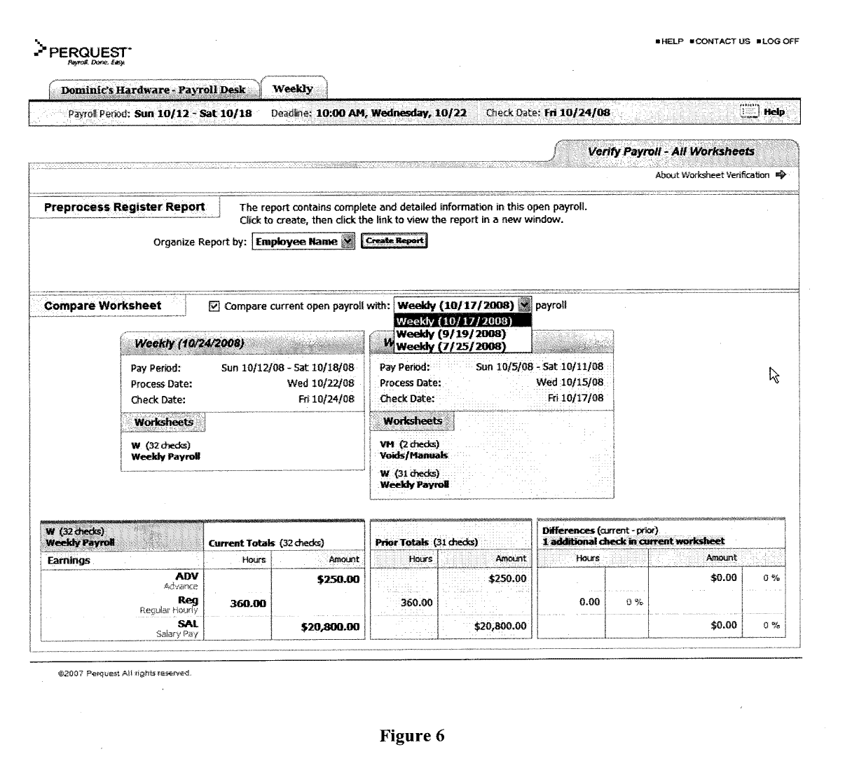

In some cases, the check information provided for a category may be the total number of checks for the category. For example, a check worksheet may provide the total number of weekly payroll checks provided. In some embodiments, all check categories may be displayed on a check worksheet, regardless of the total number of checks or information displayed regarding the check categories. In other embodiments, a check category may be displayed only if there is check information displayed relating to the check category. For example, if there are no checks within a particular check category for a time period, that check category may not be displayed. In one example, as shown in FIG. 6, there may be 32 weekly payroll checks during a first time period, and 2 void/manual checks and 31 weekly payroll checks during a second time period. Since there were no void/manual checks during the first time period, that check category may not be displayed in the check worksheet for the first time period.

In some embodiments, check information displayed on a check worksheet may include information other than total number of checks. For example, the check worksheet may list the checks provided for each check category. Or the check worksheet may divide check categories further into subcategories.

A check worksheet may also provide access to check information by providing one or more links that may direct a user to another user interface, provide an additional user interface, or modify the existing user interface to provide additional check information. In one example, a user may click on a hyperlink for a check category, and that may open up another window, or user interface where the user may view additional information relating to checks within that check categories. In some instances, the additional information may include scans of the check themselves, or electronic versions of the checks. Or a user can click on an employee's name for detail on a particular check, such as a pending manual check. Any payroll data or human capital management data relating to checks may be accessed by the link, and the additional check information may have any display format or configuration.

A time period pane with check information may include check information relating to the time period. For example, a first time period pane may include check information relating to the first time period and a second time period pane may include check information relating to the second time period. In some embodiments, the check information displayed within a time period pane may include a check total for that time period. For example, a time period pane may include the total number of checks that fall within a particular category, such as weekly payroll checks. As shown in FIG. 6, a first time period may indicate there are a total of 32 checks (i.e. in a current pay period), and a second time period may indicate there are a total of 31 checks (i.e. in a prior pay period). Any check category may be selected. In another example, a time period pane may include the total number of checks overall, summed from all of the categories. In such a situation, the first time period pane could display that there are a total of 32 checks, and the second time period pane could display that there are 33 checks (the sum of the weekly payroll checks and the void/manual checks). In other embodiments, a time period pane may include the sum of specified categories of checks, not necessarily all categories of checks. Any other check information relating to a time period may be included within a time period pane.

A differences pane may include information relating to the difference between check information provided in a first time period pane and second time period pane. For example, if the time period panes provide check totals, a differences pane may indicate a difference in check totals. For example, as shown in FIG. 6, a first time period pane may indicate a total of 32 checks, and a second time period pane indicates a total of 31 checks. A differences pane may indicate that there may be 1 additional check in the current worksheet. Depending on the check information provided in the time period panes, the information displayed by the differences pane may be formatted correspondingly. For example, if the check information within the various time period panes includes check information from various check categories, a differences pane may only indicate a difference the in the total number of checks, or may indicate the differences provided by each category of check.

The user interface displaying check information may be combined or incorporated with any other aspects of the user interface as discussed previously. For example, a check worksheet may be incorporated with a time period summary pane. In another example, time period panes may include both check information relating to that time period and data values relating to an item list for that time period.

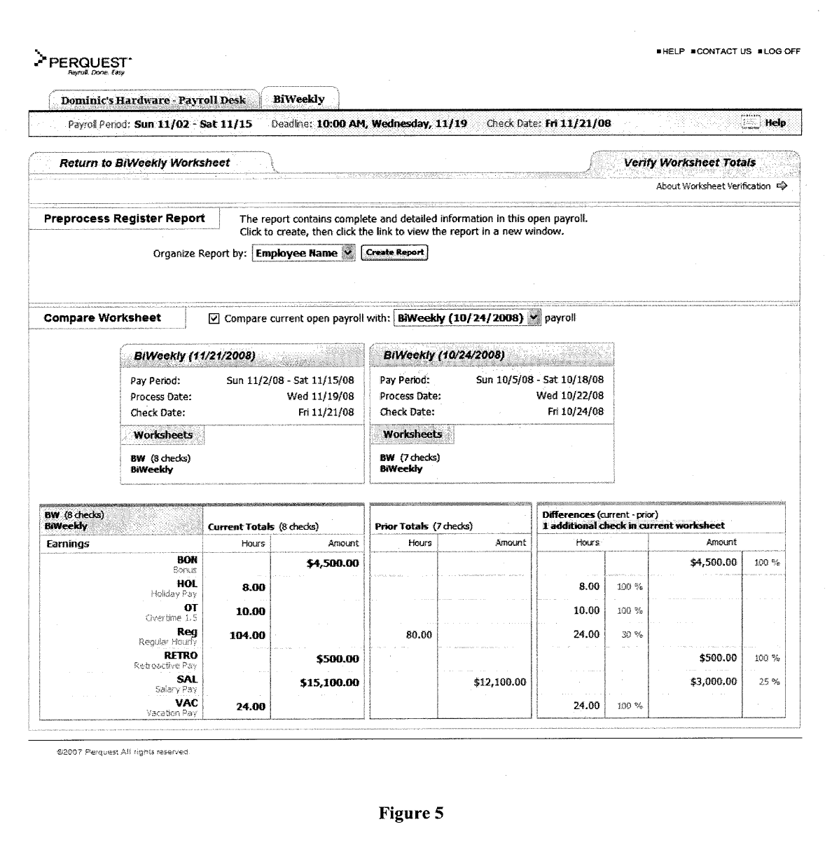

FIG. 5 shows an example of a user interface for time period comparison in accordance with one embodiment of the invention. A user interface may include a time period selection zone, a first time period summary with a first check worksheet, and a second time period summary with a second check worksheet, an item pane, a first time period details pane, a second time period details pane, and a differences pane. The user interface may accept a time period (or other basis of comparison) selection from a user through the time period selection zone. In some embodiments, the second time period summary pane, the second time period detail pane, and the differences pane may be displayed, relating to the user time period selection.

For instance, a time period selection zone may include a drop down menu, such that a current open payroll may be compared with the time period selected from the drop down menu, where the selected time period may correspond to a payroll period or other comparison basis. A first time period summary pane may indicate the current payroll period and may include information relating to the current payroll period. For example, it may include information such as dates falling within the pay period, a process date, and a check date. Similarly, a second time period summary pane may indicate the selected payroll period, and may include information relating to the selected payroll period, which may include information corresponding to the information displayed in the first payroll period. In some embodiments, time period summary panes may also include check worksheets. Check worksheets may indicate the number of checks falling within a check category and may provide links for a user to access additional information relating to the checks within the check category, or relating to the checks overall.

The first and second time period summary panes may be displayed anywhere on a user interface. In some instances, the first and second time period summary panes may be visually associated with one another. The summary panes may be arranged so that they are adjacent to one another with any orientation. For example, the summary panes may be horizontally next to one another. Alternatively, the summary panes may be aligned along a vertical orientation.

The first time period details pane and the second time period details pane may be visually associated with the first time period summary pane and the second time period summary pane respectively. For example, the first time period details pane may be displayed below the first time period summary pane, and the second time period details pane may be displayed below the second time period summary pane. Thus, a user viewing the user interface may be able to associate the data in the first time period summary pane and first time period details pane with a first time period, and the data in the second time period summary pane and the second time details pane with a second time period.

Furthermore, an item list, first time period details pane, second time period details pane, and/or differences pane may be visually mapped to one another. In some embodiments, they may be visually mapped such that they are adjacent to one another in a linear fashion. For example, they may be horizontally beside one another. In some embodiments, an item list may be adjacent to a first time period details pane, and a differences pane may be adjacent to a second time period details pane. The first time period summary pane, the first time period details pane, and the item list may form a region or zone of a user interface that may be fixed. The second time period summary pane, the second time period details pane, and the differences pane may form a region or zone of a user interface that may be variable, and that may rely on a time period selected by a user. The data values in the first time period details pane, the second time period details pane, and the differences pane may be visually mapped with items in the item list pane. For example, as discussed previously, the items and corresponding values may form a linearly horizontal line, and may be displayed in the same row.

The time period details panes may include check information for the corresponding time period, as well as data values corresponding to items in the item list and the time period. The data values may be of one or more units, and the time period details pane may have regions or zones that may allow data values of different units to be visually distinguishable from one another. For example, a first column may include data values of a unit, such as hours, and a second column may include data values of another unit, such as dollars. The differences pane may also include data values corresponding to items in the item list, and the differences in the corresponding values between the first time period and the second time period. The difference values may be displayed as an absolute value and/or relative value. For example, for an absolute value, if the difference is in hours, the number of hours different may be displayed. In another example, for a relative value, if the difference is in hours, a percentage difference may be displayed. In some embodiments, the percentage difference may be calculated as the first time period value minus the second time period value, all divided by the second time period value.

In some embodiments of the invention, all of the possible items (and/or item categories) in the item list, as well as the corresponding values, may be displayed in a user interface. Thus, even if some of the items do not have any values for the time periods being compared, the items, as well as the corresponding blank values for the items, may be included. In other embodiments, items that do not have any values in any of the time periods being compared may not be included in the item list. Thus, the user interface may only display items that have data values. Thus, the user interface may display only relevant items, where relevant items may include items with a data value during at least one of the compared time periods, or that may meet some other criteria. For example, if no bonus was provided for either time period being compared, the bonus item may not appear on the item list, and no corresponding spaces may be provided in the time period details panes.

Additionally, in some embodiments of the invention, it may be desirable to highlight significant differences in values between two or more time periods. Thus, a filter may be provided to focus on differences in value between time periods. For example, if a difference value for an item exceeds a particular absolute magnitude, or relative magnitude, that difference may be visually emphasized. Differences that exceed a particular threshold (either absolute threshold or relative threshold) may be highlighted by a visual indicator. Such visual indicator may include bolding the values, displaying the values in another color, highlighting the background near the value, displaying the value in a different font, providing an additional symbol or icon near the value, or any other visual indicator. In some embodiments, the visual indicator may be provided only to the differences value, while in other embodiments, the visual indicator may be provided to the associated time period values and item. For example, an entire row, including the payroll item, value of the payroll item during a first time period, value of the payroll item during a second time period, and differences value for the payroll item may all be highlighted. In some embodiments, only rows with difference values exceeding a threshold may be displayed. In some embodiments, the threshold may be set by the system or may be set by a user.

Alternatively, rather than further emphasizing large differences, small differences may be deemphasized. For example, all items and associated values where there are no differences, or where there are small differences that fall below a particular threshold (absolute or relative), may not be displayed. This may serve to highlight items that do have differences in values exceeding a particular threshold. Similarly, items and associated values with no or small differences may be de-emphasized by putting them in a paler color font (i.e., items with significant differences may be in normal black or other strong colored font while items with no or smaller differences may be in grey font or a pale colored font). In some embodiments, the strength of color or other visual indicators may serve to indicate either that a difference is above a threshold or below a threshold. In other embodiments, the strength of color or type of color, or any other visual indicator may be provided as a gradient, rather than as a binary indicator. For example, warmer colors may be associated with larger differences and cooler colors may be associated with smaller or fewer differences.

In some embodiments, the order of the items in the item list and corresponding item values may highlight the magnitude of differences in values. For example, items with larger differences (in absolute magnitude, or relative value) may be at a top of an item list, and items with smaller differences may be below the items with larger values, and items with no difference in values may be at the bottom of the item list or may not be displayed.

Any combination of visual indicators that may emphasize large differences and/or deemphasize small or no differences may be included. In some applications, large differences or deviations may be indicative of possible errors in entering payroll data or may indicate noteworthy events. Thus, it may be beneficial to emphasize large differences in value.

In some other embodiments of the invention, it may be desirable to highlight similarities in values between two or more time periods. Thus, a filter may be provided to focus on similarities in value between time periods. For example, if a difference value for an item remains below a particular absolute magnitude, or relative magnitude, that similarity of difference value may be visually emphasized. Similarities that remain below a particular threshold (either absolute threshold or relative threshold) may be highlighted by a visual indicator. Such visual indicator may include any visual indicator as previously discussed, or as known in the art. In some embodiments, the threshold may be set by the system or may be set by a user.

Alternatively, rather than further emphasizing small differences, large differences may be deemphasized. For example, all items and associated values where there are large differences that exceed a particular threshold (absolute or relative), may not be displayed. This may serve to highlight items that do have differences in values within a particular threshold. Similarly, items and associated values with large differences may be de-emphasized by putting them in a paler color font (i.e., items with smaller differences may be in normal black or other strong colored font while items with larger differences may be in grey font or a pale colored font). Any other visual indicator to de-emphasize larger differences may be used.

Thus, in some embodiments, any combination of visual indicators that may emphasize similarities and/or deemphasize large differences may be included. In some applications, small differences or deviations may be indicative of common values for particular items of payroll data. Thus, it may be beneficial to emphasize similarities in value.

In some embodiments, only items that are unique to one time period may be displayed and emphasized. In other embodiments, all items may be displayed and compared but items that are unique to one time period may be emphasized. These items may be emphasized with any visual indicator as discussed elsewhere. In another embodiment, only items that are found in at least two time periods (or in all time periods being compared) may be displayed and compared. In other embodiments, all items may be displayed and compared but items that are found in at least two (or all) time periods may be emphasized. These items may be emphasized with any visual indicator.

The user interface may include an interfacing mechanism that may enable a user to select how to organize a report. As with a time period selection zone, any type of user interface mechanisms known or later developed in the art to accept a user report organization selection may be used. For example, a drop down menu may be provided where a user may select how to organize the report and create a report. In some embodiments, a report may be organized by employee name, or by employee group, or by the overall company, or any other grouping or ordering that may be provided.

Selecting an option to create a report may create a precalculated display that may appear in another user interface (i.e. another display page), or within the same user interface.

In some embodiments of the invention, a user interface may display a time period comparison for a particular employee. In another example, a user interface may display a time period comparison for an employee group or division, or for any grouping of employees. In another example, a user interface may display a time period comparison for an entire company. The order of the time period comparison may be by employee name. For example a user interface may display a time period comparison for one employee at a time, and may allow a user to select another employee to view. Alternatively, a user interface may display time period comparisons for a grouping of employees at once. For example, a user may scroll down to see the time period comparisons for the employees within a grouping of employees.

The order of items displayed within an item list pane may be the same whenever a user accesses the user interface. Alternatively, other orderings of the items may be provided that may assist with comparison and validation. For example, a default ordering may be provided, such as alphabetical order, order of importance, or order of commonly included items. In some embodiments, the items may be ordered by employee types breakdown, such as hourly, salaried, or commissioned, or other human resources type employee tags, such as partners, C-levels, directors, salaried, and so forth.

The orders of items displayed within an item list pane may be sorted in any manner by which items can be sorted. In some embodiments, a user may select how items may be ordered in an item list. In other embodiments, a user interface may be automatically configured to display items in a particular type of order. Some other examples of how items may be ordered include but are not limited to: ordering items by size of payroll code (e.g., more expensive item first), ordering items with larger differences in value first, ordering items by unit group (e.g., hour units first, dollar units next), or ordering items with all regular items first and then special items next.

FIG. 6 shows an example of a user interface for time period comparison in accordance with another embodiment of the invention. A user may be able to select a variable time period or basis of comparison with a current time period. In some embodiments, the variable time period selection may include a drop down menu which may present options to a user. The options for a time period a user may select may be limited, or may include all possible time periods or bases of comparison.

As discussed previously, possible items from an item list may only be displayed if the items have any values during the time periods displayed. Alternatively, all possible items in an item list may be displayed regardless of whether they have any value during any of the time periods displayed. Furthermore, all possible items in an item list may be displayed even if there are no or small differences in value between the compared time periods. Alternatively, items in an item list may be displayed only if the differences in value between the time periods exceeds a threshold, such as when the magnitude (or absolute value) of the difference exceeds zero, or any other value.

In some embodiments, information about a current payroll period may be displayed. For example, the dates falling within a current payroll period, the deadline for the current payroll period, and the check date for the current payroll period may be displayed on the user interface.

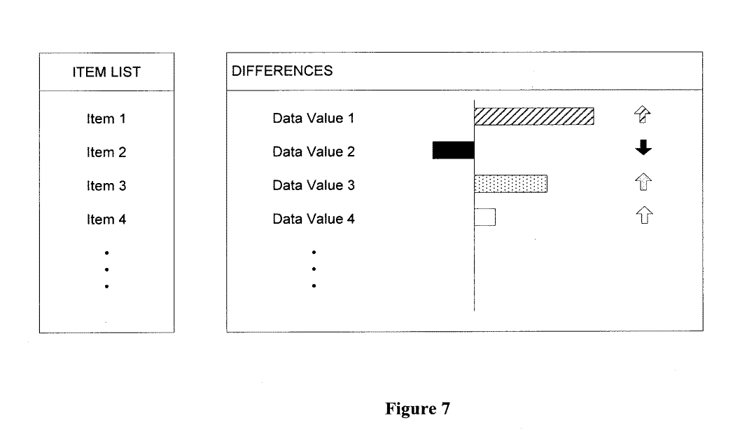

For difference comparisons between time periods, visual indicators of differences may be provided. FIG. 7 shows an example of visual difference indicators that may be incorporated into a user interface for time period comparison. Such visual indicators may be used alongside numerical data. Alternatively, such visual indicators may be used in the place of numerical data. In some instances, only one form of visual indicator may be used, while in other instances combinations of or multiple visual indicators may be used.

For instance, comparative-change magnitude bars may be used. The magnitude bars may have a horizontal orientation or a vertical orientation, or may have an orientation parallel or perpendicular to the relative orientation of a differences data value and an item in an item list. The length of the magnitude bars may correspond to the magnitude of the difference. For example, a longer magnitude bar could indicate a larger difference value. In some instances, a magnitude bar may also indicate the type of change (e.g., positive or negative change). For example, a horizontally oriented magnitude bar may be adjacent to a vertical line that may represent a zero point, and a bar to the left of the vertical line may indicate a negative change, while a bar to the right of the line may indicate a positive change. The magnitude bars may include other features that may indicate magnitude and/or direction of change, such as colors or patterns. A magnitude bar may have any shape including but not limited to a rectangle, arrow, or multiple shapes or symbols.

Another example of a visual indicator may be a trend arrow. A trend arrow may be directed upward to indicate a positive change, and may be directed downward to indicate a negative change. A trend arrow may indicate magnitude of change, based on features such as colors, patterns, length, or size. For example, certain colors or patterns may indicate greater change, or longer or larger arrows may indicate greater change. Any of these features may be combined or used separately. In some alternate implementations, the arrows may not indicate magnitude of change. However, such arrows may include additional visual features such as color or patterns that may reinforce the direction that an arrow is pointing (e.g., if an upward pointing arrow is colored green and a downward pointing arrow is colored red).

Visual indicators may also be provided when there is no change in a value. For example, an icon or dash may be provided when a difference in value is zero.

In some embodiments, a visual indicator may be used to indicate a relative weight or importance of an item. For example, some payroll items may make up a greater percentage of the overall payroll for a time period. In such instances, a visual indicator, such as a magnitude bar, may show how much of a payroll a particular item may make up. If an item were to make up 50% of the payroll, it may have a longer bar beside the item, than an item that made up 25% of the payroll.

A visual indicator may be incorporated anywhere on the user interface such that the visual indicator may be visually associated with a difference value and/or related item. For example, a visual indicator may be beside a difference value, or an item in an item list, or may be placed along a row or column that may be visually associated with an item and/or difference value.

In some embodiments, opportunities may be presented for a user to drill down into greater detail for a particular item being compared. For example, a user may select an item or difference value, or some icon visually associated with a particular item comparison. By accepting a selection a user interface may provide access to additional details about the particular item or value in any manner known in the art, including but not limited to providing the detail on the same user interface, opening an additional user interface, or directing a user to a new interface or page. Such additional details may include but are not limited to: absolute and relative difference values for an item, more details about what an item entails, how an item value may compare to various time periods or bases of comparisons, the weight an item has in an overall payroll scheme, relevant dates or times, trends relating to the item, or any visual indicators that may help convey any of the additional details.

The user interface with comparison view may be augmented by additional information on relative positioning within a wider time context. Such additional information may form an analytical perspective component of the user interface. For example, rather than comparing two or more discrete time periods or bases of comparison, a user interface may also allow a time period to be compared to a large number of other time periods, or all other time periods. For instance, a summary area may be provided that may show how a time period, such as a current pay period, fits/stands-out in comparison with all recent or annual periods. A numerical or visual comparison with such an intent may be provided. For instance, a bar chart or line chart may be provided that may show the values of an item, group of items, or all items over a specified period of time (e.g., the past year, several years, quarter, etc.), which may include a current pay period. In some embodiments, other bases of comparison may be included in the chart, such as an average value over a specified time (i.e. a line for the average over the past year), a desired value (e.g., to stay within budget), a projection of payroll item values in the future as shown by a current trend, or as desired for a budget.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A user interface for displaying human capital management data comprising:
an item list pane providing access to a list of human capital management items;
a first time period pane, providing access to data relating to a first time period and to the list of human capital management items;
a second time period pane, providing access to data relating to a second time period and to the list of human capital management items; and
a differences pane, providing access to data relating to differences in the data provided by the first time period pane and the second time period pane,
wherein the data provided by the first time period pane, the data provided by the second time period pane, and data provided by the differences pane
(i) are visually mapped to the list of human capital management items, and
(ii) comprise data in a first unit, and data in a second unit.

2. The user interface of claim 1 wherein the list of human capital management items includes at least one of: advance, bonus, holiday pay, overtime, regular hourly, retroactive pay, salary pay, or vacation pay.

3. The user interface of claim 1 wherein the list of human capital management items only contains items that are relevant during the first time period or during the second time period.

4. The user interface of claim 3 wherein items are relevant when they have a value.

5. The user interface of claim 1 wherein the first time period is a current payroll time period.

6. The user interface of claim 1 wherein the second time period is a payroll time period prior to a current payroll period.

7. The user interface of claim 1 wherein the data provided by the differences pane comprises a data value that is a data value in the first time period minus a data value in the second time period.

8. The user interface of claim 7 wherein the data value of the differences pane is provided as an absolute value and as a relative value.

9. The user interface of claim 1 wherein the first unit is dollars and the second unit is hours.

10. The user interface of claim 1 wherein the first time period pane has two opposing sides, the item list pane is adjacent to the first time period pane, and the second time period pane is adjacent to the first time period pane opposite the item list pane.

11. The user interface of claim 10 wherein the second time period pane has two opposing sides, and the differences pane is adjacent to the second time period pane opposite the first time period pane.

12. The user interface of claim 1 wherein the visual mapping occurs in a linear fashion.

13. The user interface of claim 1 further comprising check information in the first time period pane relating to the first time period, and check information in the second time period pane relating to the second time period, and check information in the differences pane relating to differences in check information between the first time period and the second time period.

14. The user interface of claim 1 further comprising a second time period selector configured to accept the second time period from a user,
wherein the data provided by the second time period pane and the data provided by the differences pane relate to the second time period provided by the user.

15. The user interface of claim 1 wherein the data provided by the differences pane that has a value exceeding a threshold value is visually emphasized.

16. The user interface of claim 1 further comprising a visual indicator for the magnitude and/or direction of the data provided by the differences pane.

17. A method of managing human capital management data comprising:
providing a user interface comprising:
a time period selection zone, capable of accepting at least one time period selection from a user;
a first time period summary pane;
a second time period summary pane;
an item list pane providing access to a list of human capital management items;
a first time period detail pane, visually associated with the first time period summary pane, providing access to data relating to the first time period and with the list of human capital management items;
a second time period detail pane visually associated with the second time period summary pane, providing access to data relating to the second time period and with the list of human capital management items; and
a differences pane, providing access to data relating to differences in the data relating to the first time period and the data relating to the second time period,
accepting at least one time period selection from a user through the time period selection zone; and
displaying the second time period summary pane, the second time period detail pane, and the differences pane, wherein the data provided by the second time period summary pane, the second time period detail pane, and the differences pane relate to the user's time period selection.

18. The method of claim 17 wherein the time period selection zone is configured to accept at least one of: a prior payroll time period, an average payroll period, or a computed benchmark period.

19. The method of claim 18 wherein the first time period is a current payroll time period.

20. The method of claim 17 wherein the first time period is fixed and the second time period is variable, or the first time period is variable and the second time period is variable.

21. The method of claim 17 wherein the time period selection zone incorporates at least one of: a drop down menu, a field, or a button.

22. The method of claim 17 wherein the data provided by the first time period pane, the data provided by the second time period pane, and the data provided by the differences pane are visually associated with the list of human capital management items in a linear fashion.

23. The method of claim 17 wherein the user interface further comprises a report organization selection zone, capable of accepting at least one organizational unit from a user.

24. The method of claim 23 wherein the organization unit is at least one of: a pay group or an employee name.

25. The method of claim 17 further comprising an analytical perspective visually displaying a value relating to the first time period as well as values relating to a plurality of time periods prior to the first time period.

26. A user interface for human capital management, comprising:
a first check worksheet comprising check information relating to a first time period, wherein the check information is provided in at least one category;
a second check worksheet comprising check information relating to a second time period, wherein the check information is provided in at least one category;
a first time period pane displaying check information relating to the first time period;
a second time period pane displaying check information relating to the second time period;
a differences pane displaying check information relating to the difference between check information relating to the first time period and check information relating to the second time period.

27. The user interface of claim 26 wherein the check information in the first check worksheet and the second check worksheet is the total number of checks within the at least one category.

28. The user interface of claim 26 wherein the at least one category includes at least one of the following: weekly payroll, voids/manuals, bonuses, or commissions.

29. The user interface of claim 26 wherein the first check worksheet or the second check worksheet provide access to an additional user interface comprising additional check information.

30. The user interface of claim 26 wherein the additional check information includes a display of the checks.

31. The user interface of claim 26 wherein the second time period is a time period prior to the first time period.
